(19) United States
(12) Patent Application Publication
(10) Pub. No.: US 2014/0289728 A1
(43) Pub. Date: Sep. 25, 2014

(54) APPARATUS, SYSTEM, METHOD, AND STORAGE MEDIUM

(71) Applicant: FUJITSU LIMITED, Kawasaki-shi (JP)

(72) Inventor: Hideki MITSUNOBU, Kawasaki (JP)

(73) Assignee: FUJITSU LIMITED, Kawasaki-shi (JP)

(21) Appl. No.: 14/170,049

(22) Filed: Jan. 31, 2014

(30) Foreign Application Priority Data
Mar. 22, 2013 (JP) 2013-059324

(51) Int. Cl. G06F 9/455

(52) U.S. Cl. CPC G06F 9/45533
USPC 718/1

(57) ABSTRACT

An apparatus includes a memory, and a processor coupled to the memory and configured to execute a process, the process including predicting a first time for transferring a packet as a predicted first time, where the predicting the first time is a prediction for transferring the packet from a second transfer circuit coupled to a second computer to a first communication circuit that transmits the packet to a network if a virtual machine is executed in the second computer, the virtual machine being executed in a first computer coupling to a first transfer circuit and generating the packet to be transmitted from a first transfer circuit to the first communication circuit through the second transfer circuit, and determining whether the virtual machine is to be executed by the second computer based on the predicted first time.

### CROSS-REFERENCE TO RELATED APPLICATION

This application is based upon and claims the benefit of priority from the prior Japanese Patent Application No. 2013-059324 filed on Mar. 22, 2013, the entire contents of which are incorporated herein by reference.

### FIELD

The embodiments discussed herein are related to an apparatus, a system, a method, and a storage medium.

### BACKGROUND

A pseudo-execution environment of an operating system (OS), which virtualizes a single server may be provided by software processing through a server. In addition, the pseudo-execution environment of the OS is called a virtual machine (VM). The VM is executed by software processing by a server, so that a plurality of VMs may be executed in a single server at the same time. In addition, the VM is executed by the software processing, so that setting may be changed to move the VM that is executed by a certain server to a further server. Pseudo-migration of the VM to the further server is performed due to the setting change, which is called migration of a VM. In addition, the migration of the VM that is executed by the certain server to the further server without terminating the VM is called live migration of a VM.

In order to manage a hardware resource that is used for the VM in the certain server, management software that is called a VM manager is executed by the further server that is different from the certain server in which the VM is executed. In addition, as migration of the VM, in order to manage the VM that may be executed across the plurality of servers, the VM manager manages hardware resources of the plurality of servers and an identification number and an operation state of the VM. In addition, the VM manager manages the VMs so that a VM is newly executed by the server, execution of the VM that is executed by the server is terminated, and the VM is migrated to the further server, depending on the usage status of the hardware resources of the plurality of servers or in response to a request from a client that utilizes the VM. In addition, power control, load distribution, and the like in a data center that includes the plurality of servers are performed when migration of the VM between the different servers is managed by the VM manager in the data center.

In addition, a packet is transmitted from the server to a network after packetization processing is executed by a network interface card (NIC) that is included in the server. Therefore, a transmission rate of the packet that is output to the network does not exceed band limitation based on a processing capability of the NIC. This is also applied to a packet that the VM that is executed by the server transmits in response to a request from the client, and the transmission rate at which the packet that is transmitted from the VM is output to the network is affected by the band limitation based on the processing capability of the NIC.

Therefore, there is a case in which a plurality of NICs are mounted on the server, and the plurality of NICs are used at the same time in order to obtain a transmission rate that exceeds band limitation of a single NIC. In this case, a band that corresponds to the number of NICs that are used at the same time may be obtained. In order to obtain a transmission rate that exceeds a processing capability of the plurality of NICs that have been already mounted on the server, it is desirable that a new NIC is mounted on the server.

A technology by which a NIC is virtualized is known as a technology by which a hardware resource of a server is virtualized. When the NIC is virtualized, the NIC may not be mounted on the server, a NIC virtualization device that includes a plurality of NICs and a transfer circuit that transfers a packet to one of the NICs, is coupled to the server. The server or a VM outputs a packet to the NIC virtualization device by specifying an identification number of an allocated NIC of the plurality of NICs. The transfer circuit that is included in the NIC virtualization device includes a switch circuit that switches a transfer destination of the packet in accordance with the identification number, and the packet is transferred to a NIC that corresponds to the identification number of the plurality of NICs when the switch circuit is controlled. In addition, packetization processing is executed for the packet by the NIC in the NIC virtualization device, and the packet is output to a network.

That is, in such a NIC virtualization device, even when the plurality of NICs are not physically mounted on the server, the server and the VM may use the plurality of NICs.

In addition, a technology is known in which a plurality of servers and a plurality of I/O devices are coupled to each other through an interconnect switch, and the plurality of servers and the plurality of I/O devices associated with each other by a plurality of virtual trees that are included in the interconnect switch. In addition, a technology is known in which logical servers and physical central processing units (CPU) are sorted, physical CPUs that are allocated to a logical server are sorted into the same group, and a memory is controlled under a memory controller to which the physical CPU belongs, so that allocation of a physical CPU is performed by considering alleviation of latency in the memory. In addition, a technology is known in which a configuration in which an I/O and a memory are closest is selected from among available connections between I/Os and memories, in which a plurality of configurations is conceivable, so that a combination of a memory and an I/O that are allocated to a VM, which is optimal in term of performance, is obtained.

Japanese Laid-open Patent Publication No. 2009-294828, Japanese Laid-open Patent Publication No. 2010-122805, and Japanese Laid-open Patent Publication No. 2012-146105 are the related art.

### SUMMARY

According to an aspect of the embodiments, an apparatus includes a memory, and a processor coupled to the memory and configured to execute a process, the process including predicting a first time for transferring a packet as a predicted first time, where the predicting the first time is a prediction for transferring the packet from a second transfer circuit coupled to a second computer to a first communication circuit that transmits the packet to a network if a virtual machine is executed in the second computer, the virtual machine being executed in a first computer coupling to a first transfer circuit and generating the packet to be transmitted from a first transfer circuit to the first communication circuit through the second transfer circuit, and determining whether the virtual machine is to be executed by the second computer based on the predicted first time.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 illustrates an example of a communication system according to an embodiment;

FIGS. 2A, 2B, 2C, 2D and 2E illustrate examples of allocation of a communication circuit in the communication system according to the embodiment;

FIGS. 3A, 3B, 3C, 3D, 3E and 3F illustrate examples of communication in the communication system according to the embodiment;

FIG. 4 illustrates an example of a hardware configuration of a management device according to the embodiment;

FIG. 5 illustrates examples of function blocks of the management device according to the embodiment;

FIG. 6 illustrates an example of processing that is executed by the management device according to the embodiment;

FIG. 7 illustrates an example of further processing that is executed by the management device according to the embodiment;

FIG. 8 illustrates an example of further processing that is executed by the management device according to the embodiment;

FIG. 9 illustrates the example of the further processing that is executed by the management device according to the embodiment;

FIG. 10 illustrates an example of further processing that is executed by the management device according to the embodiment;

FIG. 11 illustrates an example of further processing that is executed by the management device according to the embodiment; and

FIG. 12 illustrates the example of the further processing that is executed by the management device according to the embodiment.

### DESCRIPTION OF THE EMBODIMENTS

According to the study by the inventors, there is a case in which a plurality of transfer circuits each of which transfers a packet are coupled to each other, and a transfer circuit to which a server that executes a VM is coupled is different from a transfer circuit to which a communication circuit that is allocated to the VM is coupled. In this case, transfer processing may occur between the transfer circuits until a packet is delivered from the VM to the communication circuit.

Therefore, the packet that is transmitted from the VM that is executed depending on the usage status of the server is delivered to the communication circuit while being undesirably affected by transfer delay due to the transfer processing between the transfer circuits.

In the embodiments that are described later, a time that is taken deliver a packet that is transmitted from the VM that is executed depending on the usage status of the server, to the communication circuit is reduced.

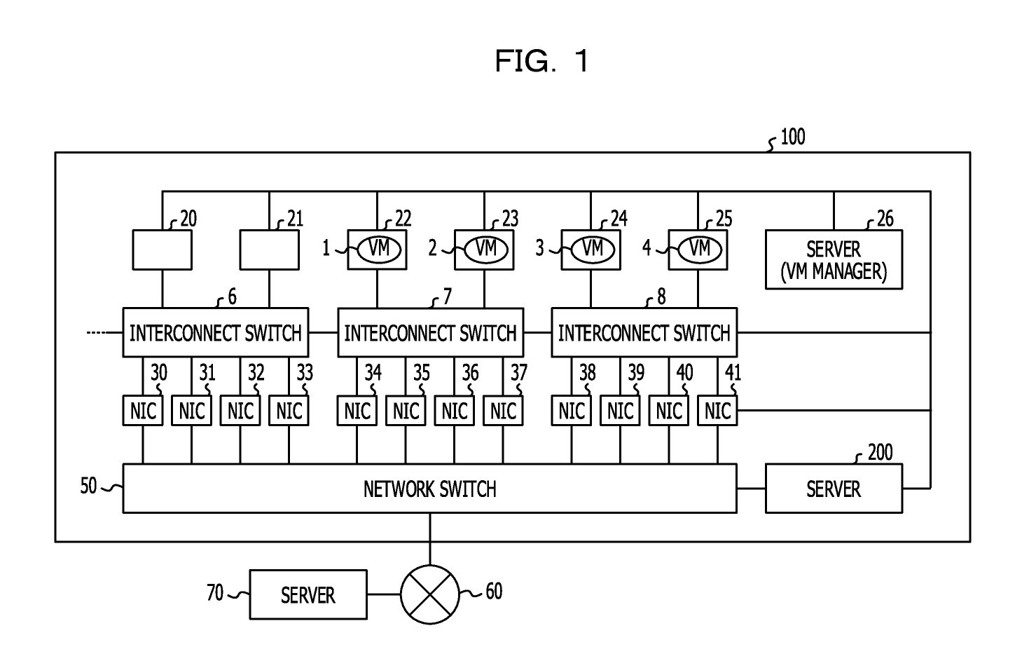

FIG. 1 illustrates an example of a communication system according to an embodiment. A data center 100 that is an example of the communication system includes a management server 200 that is an example of a management device, a server 20, a server 21, and a server 26 that has a VM manager function, a server 22 that executes a VM 1, a server 23 that executes a VM 2, a server 24 that executes a VM 3, a server 25 that executes a VM 4, an interconnect switch 6 that is an example of a transfer circuit and to which the servers 20 and 21 are coupled, an interconnect switch 7 that is an example of a transfer circuit and to which the servers 22 and 23 are coupled, an interconnect switch 8 that is an example of a transfer circuit and to which the servers 24 and 25 are coupled, NICs 30 to 33 that are examples of communication circuits and coupled to the interconnect switch 6, NICs 34 to 37 that are examples of communication circuits and coupled to the interconnect switch 7, NICs 38 to 41 that are examples of communication circuits and coupled to the interconnect switch 8, and a network switch 50 to which the NICs 30 to 41 are coupled and that is used to exchange a packet between the inside and the outside of the data center 100. In addition, the interconnect switch 6 is coupled to the interconnect switch 7, the interconnect switch 7 is coupled to the interconnect switch 8, the interconnect switches 6 and 7 transfer a packet to each other, and the interconnect switches 7 and 8 transfer a packet to each other. A packet that is output from the network switch 50 is delivered to a server 70 through a network 60. In addition, the packet that is transmitted from the server 70 is delivered to the servers 20 to 25 through the network switch 50. In addition, the servers 20 to 25 transmit and receive a packet to and from each other through the network switch 50 and the interconnect switches 6 to 8. The embodiments discussed herein are not limited to the number of management servers, the number of servers, the number of VMs, the number of interconnect switches, the number of NICs, and the number of network switches that are illustrated in FIG. 1. For example, in order to increase the number of NICs, an interconnect switch to which a server is not coupled but a NIC is coupled may be further coupled to the interconnect switch 6 or 8. In addition, in the data center 100, wiring that is applied to communication of the VMs 1 to 4 and wiring that is used to manage the servers 20 to 25 and the VMs 1 to 4 and execute migration of the VMs 1 to 4 may be separated. In addition, the management server 200 and the servers 20 to 25 correspond to physical servers by hardware that is described later.

In addition, each of the servers 20 to 25 illustrated in FIG. 1 includes a processor and a memory, and each of the VMs 1 to 4 are used to obtained a pseudo execution environment of an OS, which corresponds to a single server, is executed when a program that is stored in the memory is executed. In addition, the server 26 includes a processor and a memory, and the server 26 operates as a VM manager that manages the VMs 1 to 4 when a program that is stored in the memory is executed. In addition, in order to manage the VMs 1 to 4 that may be executed across a plurality of servers as migration of a VM, the VM manager manages hardware resources of the servers 20 to 25, and identification numbers and operation states of the VMs 1 to 4. In addition, the VM manager manages the VMs by causing the servers 20 to 25 to newly execute a VM, terminating execution of the VMs 1 to 4 that are executed by the servers 20 to 25, or migrating the VMs 1 to 4 to a further server depending on the usage status of hardware resources of the servers 20 to 25 or in response to a request from a client that uses the VM. In addition, in the data center 100 that includes the servers 20 to 25, migration of the VM between the different servers is managed by the VM manager, so that power control, load distribution, and the like are performed in the data center 100.

A NIC may not be mounted on the servers 20 to 25, and an interconnect function in each of the servers 20 to 25 is coupled to the corresponding interconnect switches 6, 7, or 8. In addition, each of the servers 20 to 25 includes an interconnect interface that is used to communicate with a NIC, and each of the VMs 1 to 4 transmits a packet to a NIC that is allocated from among the NICs 30 to 41 by the management server 200 through the interconnect interface at the time of communication. Therefore, a plurality of NICs are allowed to be adaptively allocated to the VMs 1 to 4 from among the NICs 30 to 41 without limitation of a physical connection relationship between the servers 20 to 25 and the NICs 30 to 41, and the VMs 1 to 4 are caused to execute communication in a desired band.

In addition, each of the VMs 1 to 4 to which the NIC is allocated specifies an identification information of the allocated NIC out of the NICs 30 to 41 and transmits a packet to one of the interconnect switches 6 to 8.

Each of the interconnect switches 6 to 8 includes, in the memory, a processor, a memory, and a switch circuit, and stores an identification information of a NIC, an identification information of a server, and a correspondence relationship with a port to which the NIC and the server are coupled. In addition, when a packet is received, a transfer destination of the packet is judged by the processor in accordance with identification information that is included in the packet. In addition, in accordance with the judgment result, a connection relationship of the switch circuit is controlled by the processor so that the packet is delivered to a NIC that corresponds to the identification number. By such control, the packet is transferred to the NIC that corresponds to the identification number, out of a plurality of NICs.

Each of the NICs 30 to 41 includes a processor and a memory, and the processor executes processing of a command that is transmitted and received between the interconnect switches 6 to 8 and processing of granting a media access control (MAC) address of the NIC to the arrived packet in a physical layer, in accordance with a program that is stored in the memory. The MAC address that is granted at that time is stored, for example, in a rewritable random access memory (RAM), and a value of the RAM is allowed to be set from the outside.

The network switch 50 is a switch that includes a plurality of ports that may be coupled to the NICs 30 to 41. The network switch 50 includes a processor and a memory, and the packet is routed to one of the ports in accordance with a destination MAC address that is included in the packet that is input from one of the ports. Such routing is executed by judging a transfer destination of the packet through the processor in accordance with a correspondence table between a MAC address and a port number, which is stored in the memory. Such a correspondence table is allowed to be rewritten from the outside, and when a NIC that is allocated to a VM is changed, the correspondence table is rewritten so that the packet is transferred to the changed NIC.

In addition, a service is known in which a VM is provided for a client and that is called a virtual private server (VPS). Such a VPS is provided, for example, under the environment of the communication system 100 illustrated in FIG. 1. The embodiments discussed herein are not limited to the application to the VPS.

An operator who provides the VPS manages a plurality of VMs through a VM manager to provide the service depending on the power status of a plurality of servers, the usage status of hardware resources, and the like. In this case, the client is not desired to be aware of a server that executes the VM. The client obtains the service by the VM that is executed by one of the servers, which is managed by the VM manager.

In addition, as an example of an application that is used when such a VPS is provided, there is an application that executes collection and analysis of a large amount of data that is called Big Data through combination of a plurality of VMs in order to extract valuable information and to plan and forecast future trends. In such an application, the plurality of VMs are executed at the same time, and an operation in which the pieces of data are collected to one VM and an operation in which the pieces of data are distributed to the plurality of VMs are executed. With such operations, data communication is performed between the plurality of VMs, and in some cases, communication is performed between a plurality of VMs across a plurality of data centers. Therefore, it is desirable that communication of a large amount of data is performed stably and speedy in order to execute such an application stably and speedy.

Therefore, in order to increase a communication band of a VM, there is a technology such as link aggregation, bonding, and teaming, in which a plurality of NICs are used at the same time for communication with the same point. In such a technology, the number of NICs that are allocated to a single VM at the same time is increased, and a communication band of the VM is increased depending on the number of NICs.

However, in a case of a hardware configuration in which NICs are directly mounted on a server physically, there is physical limitation for the maximum number of NICs that are allowed to be mounted to the server. Therefore, the number of NICs that are allowed to be dealt by a single VM is limited to the number of NICs that are allowed to be mounted on the single server.

In addition, a VM may be migrated between a plurality of servers, so that it is desirable that a NIC is additionally installed for all servers to which the VM may be migrated in order to increase the maximum number of NICs that are allowed to be allocated to the single VM. In addition, when a server is additionally installed, NICs are also mounted on the server that is additionally installed, by the same number as the NICs that are mounted on the server that has already operated. That is, the additional installation of a server is not independent of the additional installation of a NIC.

Therefore, as illustrated in FIG. 1, a NIC that is coupled to one of the plurality of interconnect switches that are coupled to each other is allocated to a server or a VM so that limitation that the NIC is physically mounted on the sever is removed. In the communication system illustrated in FIG. 1, the number of NICs that a single VM is allowed to use may be increased, and the additional installation of a server may be independent of the additional installation of a NIC.

When a NIC that is mounted on a server is shared with a plurality of VMs, time division is performed on a processing capability of the NIC, and the divided capabilities are allocated to the plurality of VMs. In this case, when time division is performed on processing through software, a sufficient communication speed is not obtained, so that there is a case in which a virtualization support function is provided for the NIC as hardware. Such a virtualization support function is generally provided for an expensive NIC.

In the communication system illustrated in FIG. 1, the virtualization support function may be provided for the NICs 30 to 41, but there is a case in which a large number of NICs are mounted on the communication system, so that it is desirable that a large number of inexpensive NIC are mounted on the communication system and allocated to the plurality of VMs. In addition, when the virtualization support function is not provided for the NICs 30 to 41, a single NIC is not shared with the plurality of VMs. That is, two or more NICs of a lot of NICs may be allocated to a single VM to increase the communication band, but a single NIC is not allocated to the plurality of VMs at the same time. This means that inexpensive NICs are sufficiently prepared and a communication band of the VMs is secured without physical limitation that a NIC is directly mounted on a server. In addition, in the communication system illustrated in FIG. 1, communication of a large amount of data may be performed stably and speedy between the plurality of VMs across the plurality of data center.

In addition, as illustrated in FIG. 1, in order to allow the NICs 30 to 41 to be allocated to any of the VMs 1 to 4 in response to a request, the servers 20 to 25 and the NICs 30 to 41 are coupled to each other through the interconnect switches 6 to 8. In order to increase the number of NICs that are coupled to each of the interconnect switches 6 to 8, an interconnect switch having a lot of ports is used or the number of couplings of the interconnect switch is increased. Generally, in the interconnect switch, the ports are coupled to each other through a switch matrix, so that as the number of ports is increased, a circuit scale is increased correspondingly to the square of the number of ports. In addition, with an increase in the circuit scale, the cost is also increased undesirably. In addition, when the number of ports is increased, it is desirable that switching of a switch is performed at high speed. Therefore, mere inexpensive interconnect switches in which the number of ports is small are coupled to each other, and the NICs are coupled to each of the interconnect switches. In addition, in order to obtain combination of interconnect switches in low cost, it is desirable that the number of ports that are used for packet transfer between the interconnect switches and that are not a port that is used to connect the server and the NIC is reduced.

Here, when a tree structure is used for connection between the interconnect switches, delay between the server and the NIC may be kept at a certain level, but the number of ports that are used for relay is increased. In addition, as illustrated in FIG. 1, when a cascade connection by which the interconnect switches 6 to 8 are coupled to each other is used, the number of ports that are used for packet transfer of the interconnect switches 6 to 8 may be suppressed. In the embodiment, as a connection configuration of the interconnect switches, the tree configuration may be applied, however, as illustrated in FIG. 1, a case of the cascade connection is described herein as an example.

Here, in the interconnect switch, in addition to simple switching of an electric signal, processing is executed in which identification information that is used to identify a destination that is included in a header portion of data is judged, and the switch circuit is driven. As described above, in the interconnect switch, processing such as a packet switch is desired, and in the packet transfer by the interconnect switch, processing delay that is caused in such processing occurs. In addition, even in transfer between the interconnect switches, transfer delay such as wiring delay occurs. That is, when the packet is delivered to an NIC so as to be transferred between the interconnect switches by a plurality of times, delay that is caused by combining processing delay in the interconnect switch and transfer delay that is caused by transfer between the interconnect switches is increased in proportion to the number of couplings of the interconnect switches.

Therefore, for example, in a case in which a NIC that is allocated to the VM 4 illustrated in FIG. 1 is the NIC 30, a transfer time of a packet is increased when the packet passes through the plurality of interconnect switches 6 to 8 during the transfer of the packet.

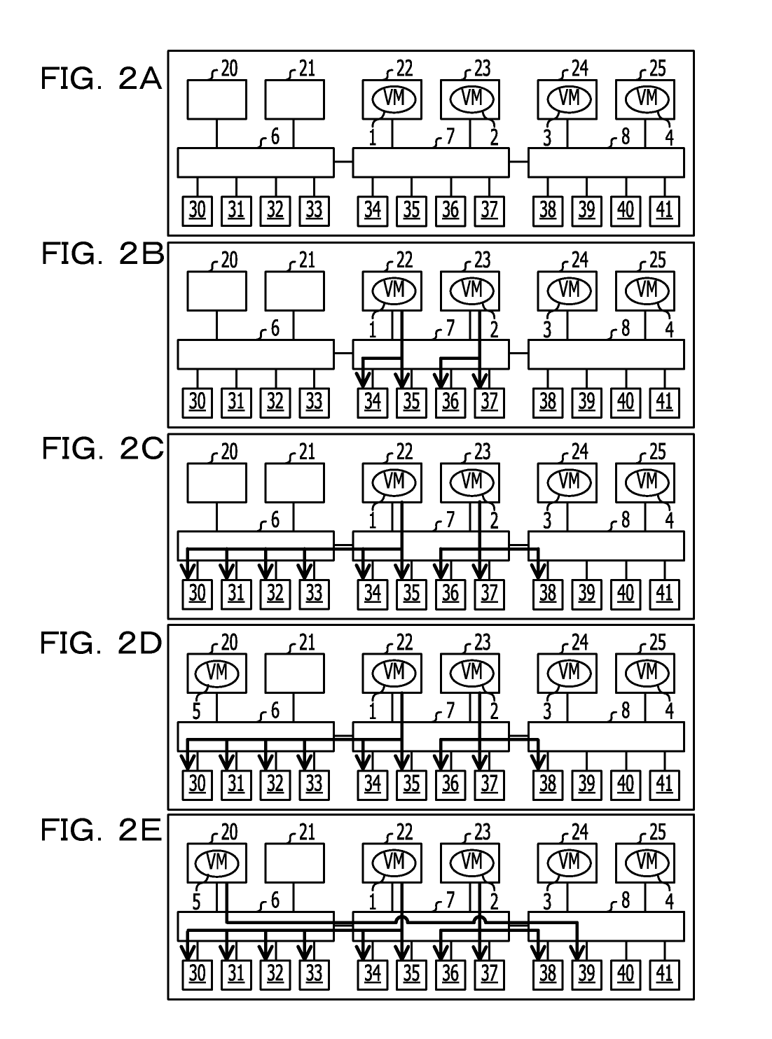

FIGS. 2A, 2B, 2C, 2D and 2E illustrate examples of allocation of a communication circuit in the communication system according to the embodiment. In order from the examples of FIGS. 2A to 2E, a procedure in which a plurality of NICs is allocated to a VM is described. In FIGS. 2A to 2E, to configuration elements that are similar to that of FIG. 1, the same reference numerals are given, and configuration elements the descriptions of which are desired are merely illustrated.

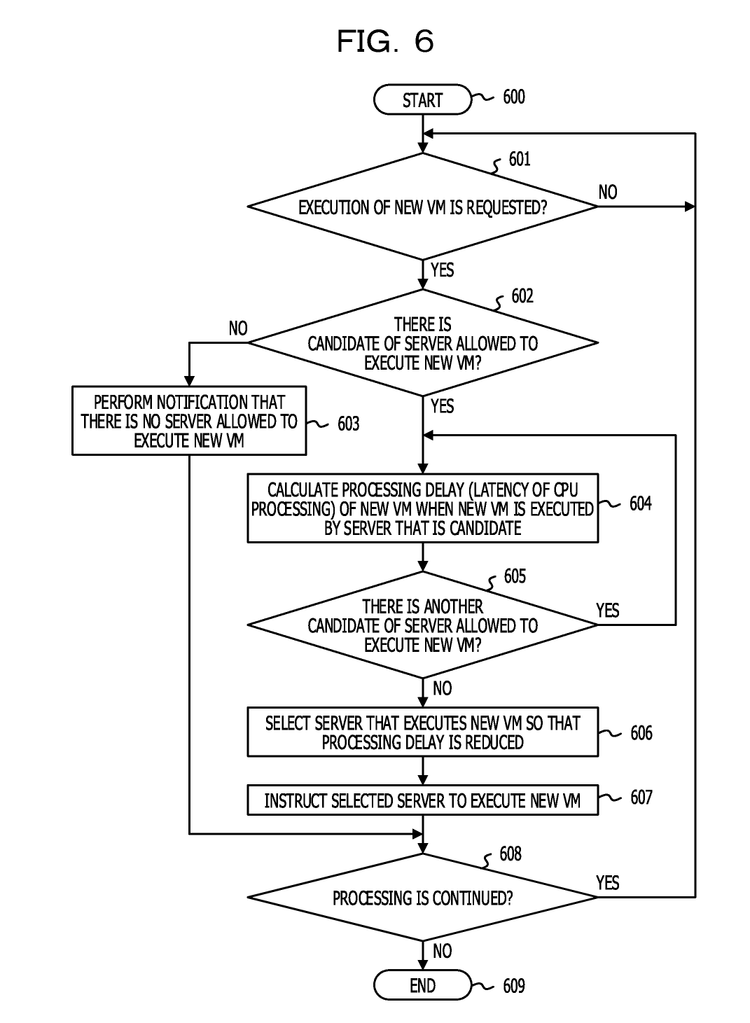

In FIG. 2A, the server 20, the server 21, the server 22 that executes the VM 1, the server 23 that executes the VM 2, the server 24 that executes VM 3, the server 25 that executes the VM 4, the interconnect switch 6 to which the servers 20 and 21 are coupled, the interconnect switch 7 to which the servers 22 and 23 are coupled, the interconnect switch 8 to which the servers 24 and 25 are coupled, the NICs 30 to 33 that are coupled to the interconnect switch 6, NICs 34 to 37 that are coupled to the interconnect switch 7, and the NICs 38 to 41 that are coupled to the interconnect switch 8 are illustrated. By connecting the interconnect switches 6 and 7 to each other and connecting the interconnect switches 7 and 8 to each other, the interconnect switches 6 to 8 are coupled to each other. In addition, the VMs 1 to 4 are executed, for example, by processing of FIG. 6, which is described later, but the NICs 30 to 41 are not allocated to any of the VMs 1 to 4.

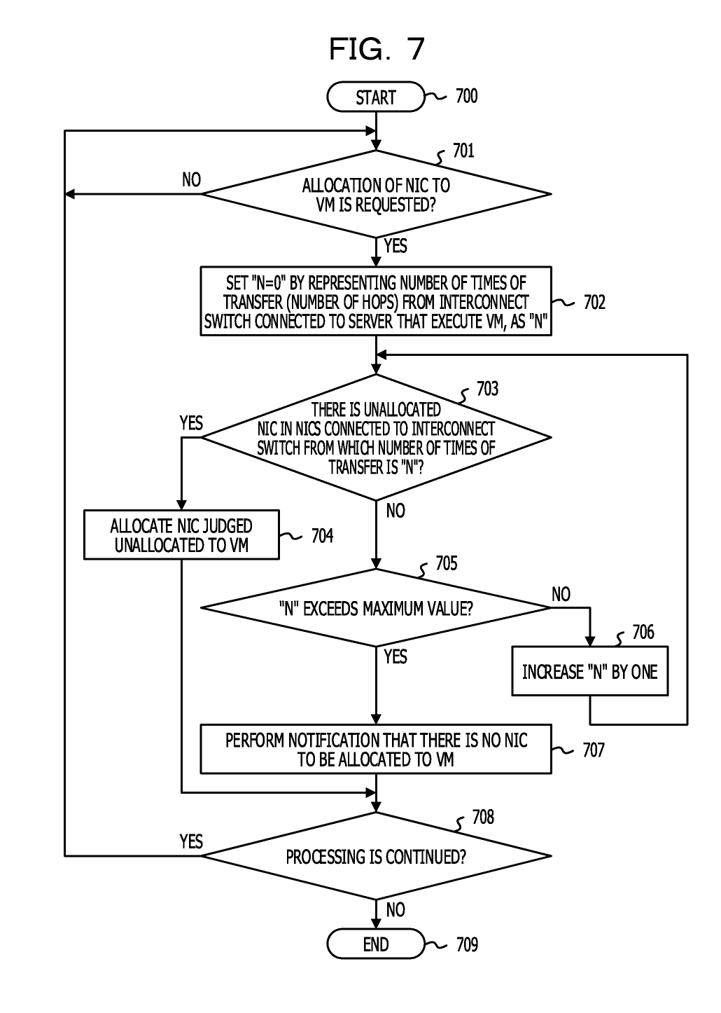

In FIG. 2B, a case is illustrated, as a result of a request of allocation of NICs by the VMs 1 and 2, the NICs 34 and 35 are allocated to the VM 1, the NICs 36 and 37 are allocated to the VM 2, for example, by processing of FIG. 7, which is described later. As described above, unallocated NICs for which a packet transfer time is reduced as much as possible are allocated to the VMs 1 and 2. At this point, there is no unallocated NIC in the NICs 34 to 37 that are coupled to the interconnect switch 7.

In FIG. 2C, a case is illustrated in which, as a result of a request of allocation of NICs by the VMs 1 and 2 in order to further increase a communication band, the NICs 30 to 35 are allocated to the VM 1, and the NICs 36 to 38 are allocated to the VM 2. In the embodiment, because the NICs 30 to 41 are not physically mounted on the servers 20 to 25, for example, even when there is no unallocated NIC in the NICs that are coupled to the interconnect switch 7 to which the server 22 is coupled, the VM 1 may use the NICs 30 to 33 for which packet transfer delay becomes smaller, from among the unallocated NICs as long as there are unallocated NICs that are coupled to the interconnect switches 6 and 8 other than the interconnect switch 7.

In FIG. 2D, an example is illustrated in which a new VM 5 is executed by the server 20. In this example, for example, the VMs have been already executed in the servers 22 to 25, and there is processing delay due to context switch of a CPU, and the like in the servers 22 to 25, so that in accordance with the processing of FIG. 6, which is described later, the server 20 in which a VM is not executed yet is judged as a server in which processing delay becomes smaller, and the VM 5 is executed by the server 20.

In FIG. 2E, an example is illustrated in which, as a result of a request of allocation of a NIC by the VM 5 that is newly executed by the server 20, a NIC 39 is allocated to the VM 5. For example, when the VM 5 requests allocation of a NIC, the NIC is searched for by the processing illustrated in FIG. 7 so that a packet transfer time is reduced as much as possible, but the NIC 39 is allocated to the VM 5 ultimately because the NICs 30 to 33 that are coupled to the interconnect switch 6 has been already used by the VM 1, and the NICs 34 to 38 have been also used. If, for example, the VM 1 frees up the allocation of the NIC 30 at the time at which the VM 5 requests allocation of a NIC, the NIC 30 is allowed to be allocated to the VM 5.

As described above, a packet passes through the interconnect switches of the multi-stages before the packet that is transmitted from a VM is delivered to a NIC depending on the allocation status of NICs, so that a time that is taken to perform packet transfer is increased undesirably. In addition, in a period in which the packet transfer is performed, the other VMs are not allowed to occupy the interconnect switches and the like, so that the packet transfer delay affects the communication performance of the other VMs. In addition, as a communication amount of the VM is increased, a time that is taken to perform the packet transfer is increased, so that an effect on the communication performance of the other VMs is also increased undesirably. For example, when the VM 5 executes communication having a large communication amount, in a period in which the VM 5 uses the interconnect switches 7 and 8, the VMs 1 to 4 wait for the usage of the interconnect switches 7 and 8, so that the whole communication performance is reduced undesirably.

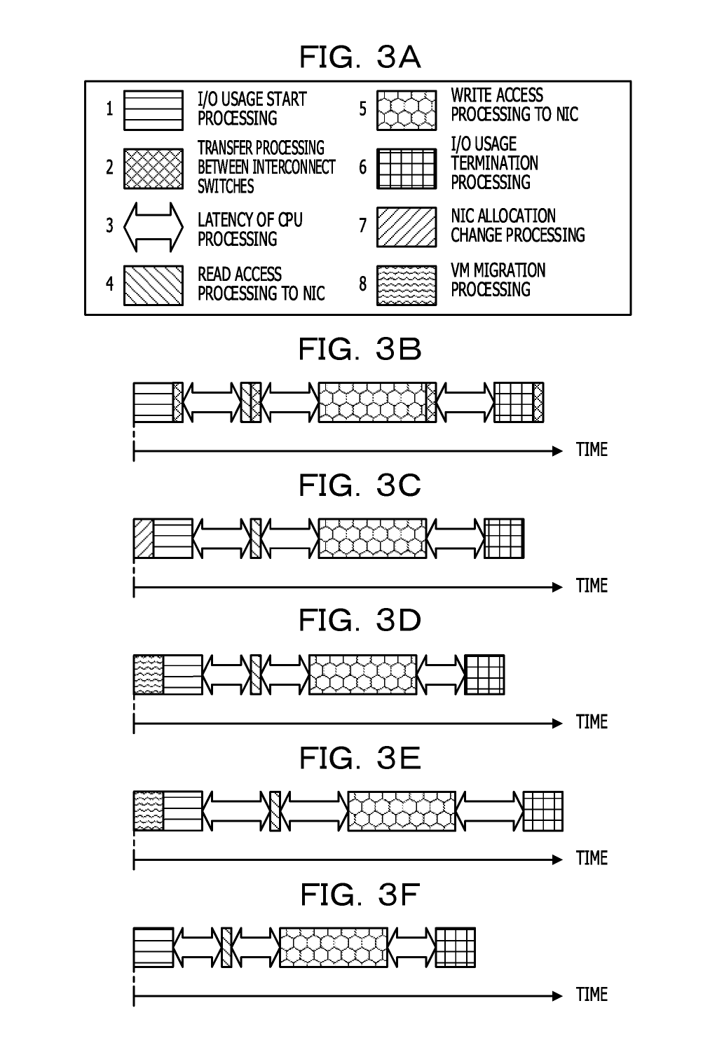

FIGS. 3A, 3B, 3C, 3D, 3E and 3F illustrate examples of communication in the communication system according to the embodiment. In FIGS. 3B to 3F, time charts of pieces of processing until a VM completes transmission of a packet, and in FIG. 3A, a key in the time width of the pieces of processing that are indicated in the time charts are illustrated.

The key illustrated in FIG. 3A includes I/O usage start processing 1 that is a preparation period in which a VM performs checking the relationship with a NIC at first in order to start transmission of a packet, transfer processing 2 between interconnect switches when the packet passes through the interconnect switches of the multi-stages, latency 3 of CPU processing of context switch and the like, read access processing 4 that is related to polling for checking a state of a transmission/reception buffer that is included in the NIC and waiting until communication is completed, write access processing 5 of writing the packet to the NIC and changing setting of a MAC address, a packet length, and the like by the NIC, I/O usage termination processing 6, NIC allocation change processing 7, and VM migration processing 8.

In FIG. 3B, a time chart of communication is illustrated when an interconnect switch that is coupled to a server that executes a VM and an interconnect switch to which a NIC that is allocated to the VM is coupled are different, and a packet passes through interconnect switches of the multi-stages, which are coupled to each other until the packet is delivered from the VM to the NIC. In pieces of processing other than the latency 3 of the CPU processing, which is processing delay in the server, the packet passes through the interconnect switches of the multi-stages, which are coupled to each other, so that the transfer processing 2 between the interconnect switches occurs depending on the number of times in which the packet passes through the interconnect switches.

In the time chart of FIG. 3B, a series of pieces of processing of transmitting at least one packet is illustrated, and in a typical example, it takes about 10 microseconds to execute the series of pieces processing. In addition, in the typical example, a time that is taken to execute the transfer processing 2 between the interconnect switches is one microsecond that is about 10% of the whole time. In the series of pieces of processing of FIG. 3B, the processing 4 and the processing 5 are merely executed by one time each, but the embodiments are not limited to such an example, and the series of pieces of processing may be executed several times depending on the communication status. This is also applied to examples of FIGS. 3C to 3F, which are described later.

In addition, when the VM continues to perform the communication, such series of pieces of processing is executed by a plurality of times. For example, when 100 million packets are transmitted within a period until the VM is terminated, it takes 1000 seconds to transmit all of the packets. That is, a difference among times in FIGS. 3B to 3F is increased in proportion to the number of times of packet transmission that is performed in the period until the VM is terminated.

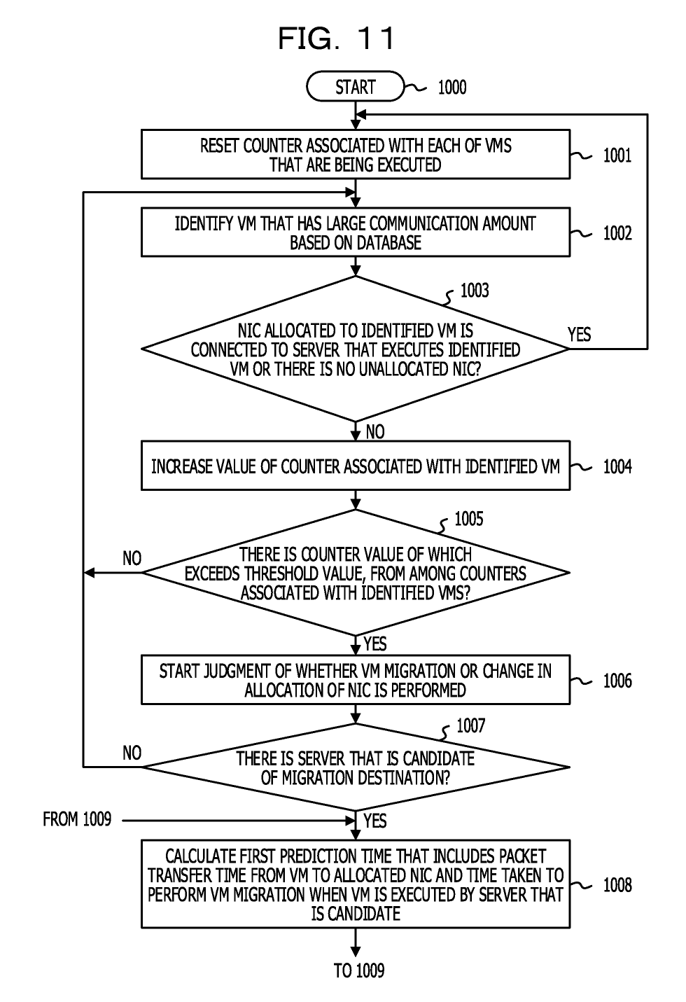

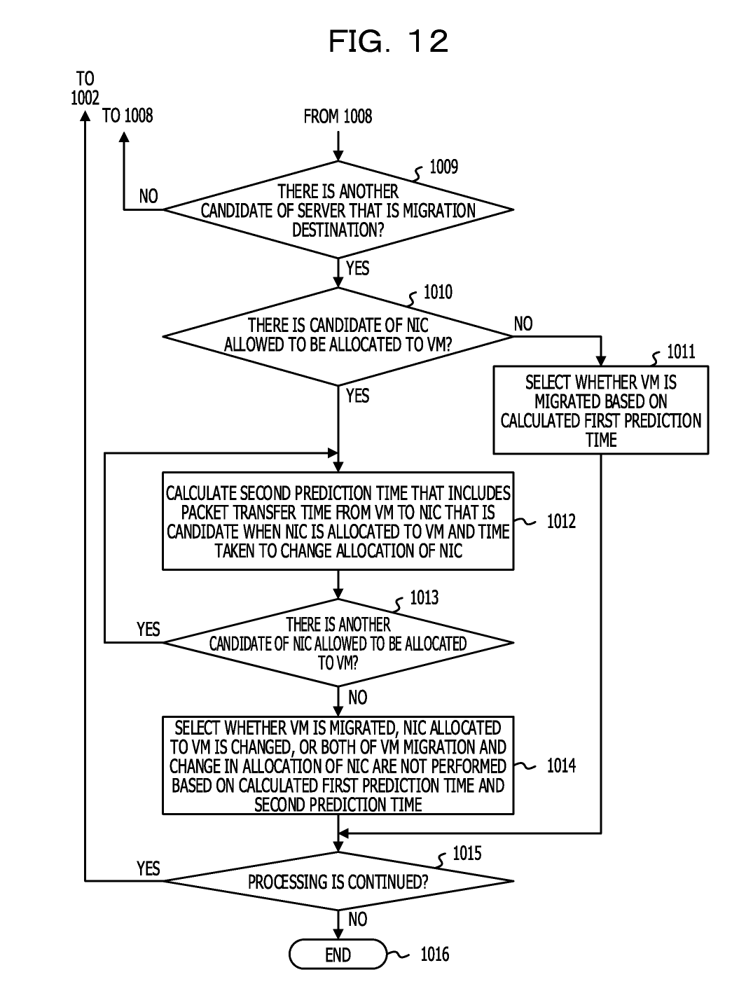

In FIG. 3C, a time chart of communication is illustrated when an unallocated NIC is generated due to change in the usage status of NICs, a NIC that is allocated to a VM is changed in accordance with processing illustrated in FIGS. 11 and 12, which are described later. In FIG. 3C, an example is illustrated in which a server that executes the VM and the NIC are coupled to the same interconnect switch by changing allocation of the NIC.

The server that executes the VM and the NIC are coupled to the same interconnect switch, the time that is taken to execute the transfer processing 2 between the interconnect switches is reduced as compared with FIG. 3B. However, the allocation of the NIC is changed, so that a time that is taken to execute the NIC allocation change processing 7 is added to the beginning of the time chart. In subsequent packet transmission, the time that is taken to execute the NIC allocation change processing 7 is not desired. In addition, the server that executes the VM is not changed, so that the latency of the CPU processing is similar to that of FIG. 3B.

In FIG. 3C, the time that is taken to execute the NIC allocation change processing 7 is increased because the allocation of the NIC is changed, but the time that is taken to execute the transfer processing 2 between the interconnect switches is reduced, so that, as a whole, the time that is taken to perform packet transmission is reduced as compared with FIG. 3B. For example, a time that is taken to transmit a single packet is reduced by 10%, and 110,000 times of packet transmission is allowed to be performed per one second. In this case, a time that is taken to transmit 100 million packets becomes 910 seconds by including a time that is taken to change the allocation of the NIC, so that highly efficient communication is performed as compared with the example illustrated in FIG. 3B. The embodiments are not limited to such an example, and there is a case in which the time that is taken to executes the transfer processing 2 between the interconnect switches is reduced, and as a whole, the time that is taken to perform packet transmission is reduced as long as the number of times of transfer between the interconnect switches through which the packet passes is reduced even when the number of times of transfer is not zero after the allocation of the NIC is changed.

In FIG. 3D, a time chart of communication is illustrated when the server that executes the VM is allowed to be changed due to change in the usage status of the servers, and the VM is migrated to a server in which latency of CPU processing of the context switch and the like becomes less in accordance with the processing illustrated in FIGS. 11 and 12, which is described later. Here, an example is illustrated in which the server that executes the VM and the NIC are coupled to the same interconnect switch by migrating the VM.

In FIG. 3D, a time that is taken to execute the VM migration processing 8 is reduced because the server that executes the VM is changed, but the time that is taken to execute the transfer processing 2 between the interconnect switches is reduced, and the latency 3 of the CPU processing is reduced due to the server in which the context switch is less. Therefore, as a whole, the time that is taken to perform packet transmission is reduced as compared with FIG. 3B.

For example, as compared with FIG. 3B, a time is reduced by 10% because the time that is taken to execute the transfer processing 2 between the interconnect switches is reduced, and a time is further reduced by 10% because the latency 3 of the CPU processing is reduced, so that, as a whole, the time is reduced by 20%. Therefore, 120,000 times of packet transmission is allowed to be performed per one second. In this case, the time that is taken to transmit 100 million packets becomes 863 seconds by including the time that is taken to perform VM migration, so that highly efficient communication is performed as compared with the example illustrated in FIG. 3B.

The embodiments are not limited to such an example, and there is a case in which the time that is taken to execute the transfer processing 2 between the interconnect switches is reduced, and as a whole, the time that is taken to perform packet transmission is reduced as long as the number of times of transfer between the interconnect switches through which the packet passes is reduced even when the number of times of transfer is not zero after the VM is migrated.

In a case in which a communication amount of the VM is large, when the NIC allocation is changed as illustrated in FIG. 3C, or the VM is migrated as illustrated in FIG. 3D, a reduction effect of the time that is taken to perform packet transmission is high. However, in a case in which a communication amount of the VM is small, the time that is taken to execute the NIC allocation change processing 7 or the time that is taken to execute the VM migration processing 8 becomes longer than the time that is taken to execute the read access processing 4 to the NIC and the time that is taken to execute the write access processing 5 to the NIC undesirably even when the transfer processing 2 between the interconnect switches may be reduced because the time that is taken to execute the read access processing 4 to the NIC and the time that is taken to execute the write access processing 5 to the NIC are small, so that there may occur disadvantages for the packet transmission. Therefore, it is desirable that a communication amount of the VM is considered. In addition, as described later, a communication amount of the VM is monitored by the management server 200, on the basis of the packets that are input by the network switch 50.

In FIG. 3E, an example is illustrated in which the time that is taken to execute the VM migration processing 8 is increased, but the time that is taken to execute the transfer processing 2 between the interconnect switches is reduced because the server that executes the VM is changed. However, the VM is migrated to a server in which the latency 3 of the CPU processing of the context switch and the like becomes longer, so that, as a whole, the time that is taken to perform packet transmission is increased as compared with FIG. 3B.

In order to increase a communication band of the VM, as described above, it is desirable that the number of NICs that are used by the single VM at the same time is increased, and it is desirable that the VM uses the plurality of NICs at sufficiently high speed. The plurality of VMs may be executed on the single server at the same time, processing of each of the VMs is executed through time division. At that time, switching processing of register/memory arrangement and the like, which is called context switch is desired for switching of the VM, and a time is consumed for such processing. As the number of VMs is increased, the number of times of context switch is increased, and as a result, the operation speed of each of the VMs is reduced undesirably. In order to cause the VM to drive the plurality of NICs at sufficiently high speed, it is desirable that the arrangement of the VMs is considered so that a lot of VMs is not concentrated on the single server.

In FIG. 3F, for example, an example is illustrated in which the latency 3 of the CPU processing in a VM that has been already executed by a server that is a migration destination is increased when a VM that is a migration target is migrated as illustrated in FIG. 3D. That is, when the VM that is migration target is merely considered, the reduction effect seems to be obtained as long as the time that is taken to execute the VM migration processing exceeds a packet transfer time that is reduced by the transfer delay through the interconnect switches of the multi-stages and the latency of the CPU processing. However, there is an increased portion of the latency of the CPU processing of the VM other than the migration target because there is the VM that is being executed in the migration destination. Therefore, it is desirable that the increased portion of the latency of the CPU processing of the VM other than the migration target is considered so that the reduction effect is obtained as the whole system. In the processing according to the embodiment, the increased portion of the latency of the CPU processing of the VM other than the migration target is considered.

As described above, a difference between the examples in FIGS. 3B to 3F is increased in proportion to the number of times of packet transmission in a period until the VM is terminated, so that it is desirable that a server that executes the VM and a NIC that is allocated to the VM are appropriately selected.

In accordance with processing according to an embodiment that is described later, in a communication system in which a packet is transmitted from one interconnect switch to which a server that executes a VM is coupled, to a NIC through a further interconnect switch, it is judged whether the VM is executed by a further server that is coupled to the further interconnect switch.

In addition, in this case, a total value of a time that is taken for migration when the VM is executed by the further server and a time that is taken to deliver the packet that is transmitted from the migrated VM, to the NIC that is coupled to the further interconnect switch is compared with a total value of a time that is taken to execute processing of changing the NIC that is allocated to the VM, to the NIC that is coupled to the interconnect switch to which the server that executes the VM is coupled and a time that is taken to deliver the packet from the VM to a newly allocated NIC after the NIC that is allocated to the VM is changed, and it is selected whether the VM is migrated or allocation of the NIC is changed so that the transfer time of the packet from the VM to the NIC becomes short.

Therefore, even when interconnect switches of the multi-stages between which the packet is transferred are coupled, and an interconnect switch to which the server that executes the VM is coupled is different from an interconnect switch to which the NIC that is allocated to the VM is coupled, a time that is taken to deliver the packet that is transmitted from the VM that is being executed depending on the usage status of the server, to the NIC is allowed to be reduced.

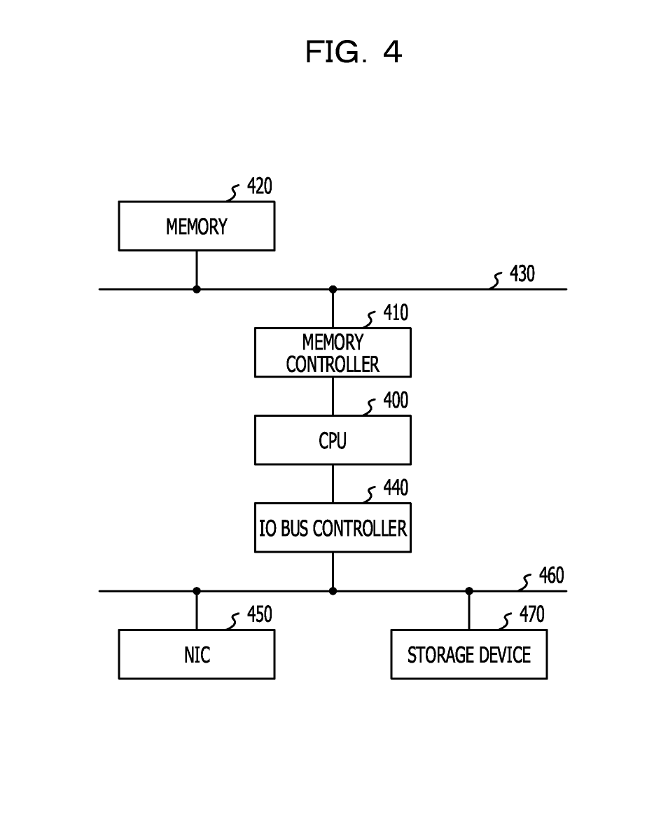

FIG. 4 illustrates an example of a hardware configuration of the management device according to the embodiment. The management server 200 that is an example of a management device includes a CPU 400, a memory controller 410, a memory 420, a memory bus 430, an IO bus controller 440, a NIC 450, and an IO bus 460, and a storage device 470 is coupled to the IO bus 460.

In the memory 420 that is coupled to the memory bus 430, a program that is used to execute various pieces of processing of the management server 200 is stored. The CPU 400 reads out the program from the memory 420 through the memory controller 410 and executes the various pieces of processing. With the execution of the various pieces of processing by the CPU 400, write and read of data are performed for the memory 420 through the memory controller 410.

The CPU 400 transfers the data to the NIC 450 that is coupled to the IO bus 460, through the IO bus controller 440, and receives data and a packet from the NIC 450. The CPU 400 reads out data from the storage device 470 that is coupled to the IO bus 460, through the IO bus controller 440, and writes data into the storage device 470.

The CPU 400 may include one or more CPU cores that are used to execute various pieces of processing. In addition, each of the CPU cores may include one or more processors. The memory 420 is, for example, a RAM such as a dynamic random access memory (DRAM). The storage device 470 is, for example, a non-volatile memory such as a read only memory (ROM) and a flash memory, or a magnetic disk device such as a hard disk drive (HDD).

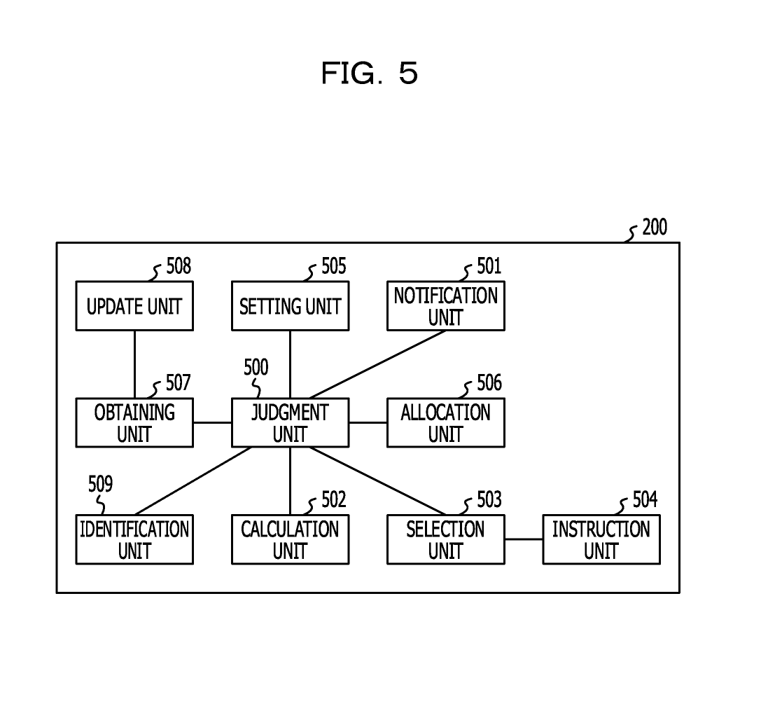

A configuration in which the CPU 400, the memory controller 410, the memory 420, the NIC 450, and the storage device 470 are coupled to the same bus may be applied to the management server 200. The function blocks illustrated in FIG. 5 are obtained by the hardware configuration illustrated in FIG. 4, and the pieces of processing illustrated in FIGS. 6 to 12 are executed.

FIG. 5 illustrates examples of the function blocks of the management device according to the embodiment. The management server 200 that is an example of a management device functions as a judgment unit 500, a notification unit 501, a calculation unit 502, a selection unit 503, an instruction unit 504, a setting unit 505, an allocation unit 506, an obtaining unit 507, an update unit 508, and an identification unit 509 when a program that is loaded to the memory 420 that is used as a working memory is executed by the CPU 400. Processing that is executed by each of the function blocks illustrated in FIG. 5 corresponds to the pieces of processing illustrated in FIGS. 6 to 12, which are described later.

FIG. 6 illustrates an example of processing that is executed by the management device according to the embodiment. The processing illustrated in FIG. 6 is processing of instructing a server that executes a VM to the server 26 that is a VM manager by the management server 200 illustrated in FIG. 1 when a request that causes a new VM to be executed is received, and allocation of a NIC is not requested to the VM at the time of execution of the new VM. The processing illustrated in FIG. 6 may be executed by the server 26. First, in an operation 600, the processing illustrated in FIG. 6 is started.

In an operation 601, the judgment unit 500 judges whether execution of the new VM is requested. When the judgment unit 500 judges that the execution of the new VM is not requested, the operation 601 is repeated in order to continue to monitor the request. When the judgment unit 500 judges that the execution of the new VM is requested, the flow proceeds to an operation 602.

In the operation 602, the judgment unit 500 judges whether there is a candidate of a server that is allowed to execute the new VM. In the operation 602, the judgment unit 500 judges whether there is a candidate of a server that is allowed to execute the new VM in accordance with the usage status of hardware resources of the server 26 that is a VM manager and the servers 20 to 25 that are running and monitored by the management server 200, and the power control status in the data center 100. When the judgment unit 500 judges whether there is no candidate of the server, the flow proceeds to an operation 603. When the judgment unit 500 judges whether there is a candidate of the server, the flow proceeds to an operation 604.

In the operation 603, the notification unit 501 performs notification that there is no server that is allowed to execute the new VM. The judgment unit 500 judges that there is no server that has enough hardware resources to allow the new VM to be executed in the operation 602, so that the notification unit 501 performs notification that there is no server that is allowed to execute the new VM, on the basis of the judgment result in the operation 603. When the operation 603 is terminated, the flow proceeds to an operation 608.

When the judgment unit 500 judges that there is a candidate of the server in the operation 602, the calculation unit 502 calculates processing delay of the new VM when the new VM is executed by the server that is the candidate in the operation 604. In the operation 604, for example, when the new VM is executed in addition to the VM that has been already executed by the server that is the candidate, latency of CPU processing such as context switch of a CPU is calculated.

In an operation 605, the judgment unit 500 judges whether there is a further candidate of the server that is allowed to execute the new VM. When the judgment unit 500 judges that there is a further candidate of the server, the flow proceeds to the operation 604 in order to calculate processing delay of the new VM when the server that is the further candidate executes the new VM. When the judgment unit 500 judges that there is no candidate of the server any more, the flow proceeds to an operation 606.

In the operation 606, the selection unit 503 selects the server that executes the new VM so that the processing delay is reduced. In the operation 606, pieces of processing delay of servers that are candidates are compared with each other on the basis of the calculation result that is obtained in the operation 604, and a server in which the processing delay is reduced is selected as the server that executes the new VM.

In the operation 607, the instruction unit 504 instructs the selected server to execute the new VM. In the operation 607, for example, the instruction unit 504 issues an instruction to the server 26 that is a VM manager so that the server that is selected in the operation 606 is caused to execute the new VM.

In an operation 608, the judgment unit 500 judges whether the processing is continued. When the judgment unit 500 judges that the processing is continued, the flow proceeds to the operation 601. When the judgment unit 500 judges that the processing is not continued, the flow proceeds to an operation 609, and the processing illustrated in FIG. 6 is terminated in the operation 609.

FIG. 7 illustrates an example of further processing that is executed by the management device according to the embodiment. The processing illustrated in FIG. 7 is processing of allocating a NIC to a VM so that the VM is allowed to perform communication when the VM is executed by server, but the NIC is not allocated to the VM yet. As illustrated in FIG. 2, there is a case in which a NIC has been already allocated to one of the VMs, so that transfer from the transfer circuit to the NIC is considered and an unallocated NIC is searched for in the processing illustrated in FIG. 7. First, in an operation 700, the processing illustrated in FIG. 7 is started.

In the operation 701, the judgment unit 500 judges whether allocation of the NIC to the VM is requested. When the judgment unit 500 judges that the allocation is not requested, the operation 701 is repeated in order to continue to monitor the request. When the judgment unit 500 judges that the allocation is requested, the flow proceeds to an operation 702.

In the operation 702, the setting unit 505 sets “N=0” by representing the number of times of transfer from the interconnect switch that is coupled to the server that executes the VM, as “N”. In the operation 702, the number of times (the number of hops) in which the packet that is transmitted from the VM is transferred between the interconnect switches is represented as “N”, and zero is set as an initial value of “N”. For example, an interconnect switch from which the number of times of transfer is zero corresponds to an interconnect switch that is coupled to the server that executes the VM, and an interconnect switch from which the number of times of transfer is one corresponds to an interconnect switch that is directly coupled to the interconnect switch that is coupled to the server that executes the VM. When zero is set to “N”, a NIC is searched for so that the number of times of transfer from the interconnect switch is reduced as least as possible, using the server that executes the VM as a reference.

In an operation 703, the judgment unit 500 judges whether there is an unallocated NIC in NICs that are coupled to the interconnect switch from which the number of times of transfer is “N”. As illustrated in FIG. 2, there is a case in which the NICs has been already allocated to one of the VMs, so that in the NICs that are coupled to the transfer circuit from which the number of times of transfer is “N”, the judgment unit 500 judges that there is an unallocated NIC in the operation 703. When the judgment unit 500 judges that there is an unallocated NIC, the flow proceeds to an operation 704, and when the judgment unit 500 judges that there is no unallocated NIC, the flow proceeds to an operation 705.

In the operation 704, the allocation unit 506 allocates the NIC that is judged unallocated, to the VM. The operation 703 is executed after the operation 702, so that the judgment unit 500 judges that a NIC to which the number of times of transfer from the server that executes the VM is small as least as possible is an unallocated NIC, and such an unallocated NIC is allocated to the VM that requests allocation of the NIC in the operation 704.

In the operation 705, the judgment unit 500 judges whether “N” exceeds the maximum value when it is judged that there is no unallocated NIC in the operation 703. When “N” exceeds the maximum value, for example, the number of times of transfer from the transfer circuit to which the server that executes the VM is coupled becomes maximum depending on the number of interconnect switches and the connection configuration. The maximum value may be set to be small as compared with the number of interconnect switches and the connection configuration.

When the judgment unit 500 judges that “N” does not exceed the maximum value, the setting unit 505 performs setting so that “N” is increased by 1 in an operation 706. In addition, the flow proceeds to the operation 703 in order to judge whether there is an unallocated NIC when the number of times of transfer is increased by increasing “N”. In addition, when the judgment unit 500 judges that “N” exceeds the maximum value, the notification unit 501 performs notification that there is no NIC that is to be allocated to the VM in an operation 707.

In an operation 708, the judgment unit 500 judges whether the processing is continued after the operation 704 or the operation 707. When the judgment unit 500 judges that the processing is continued, the flow proceeds to the operation 701, and when the judgment unit 500 judges that the processing is not continued, the flow proceeds to an operation 709, and the processing illustrated in FIG. 7 is terminated in the operation 709.

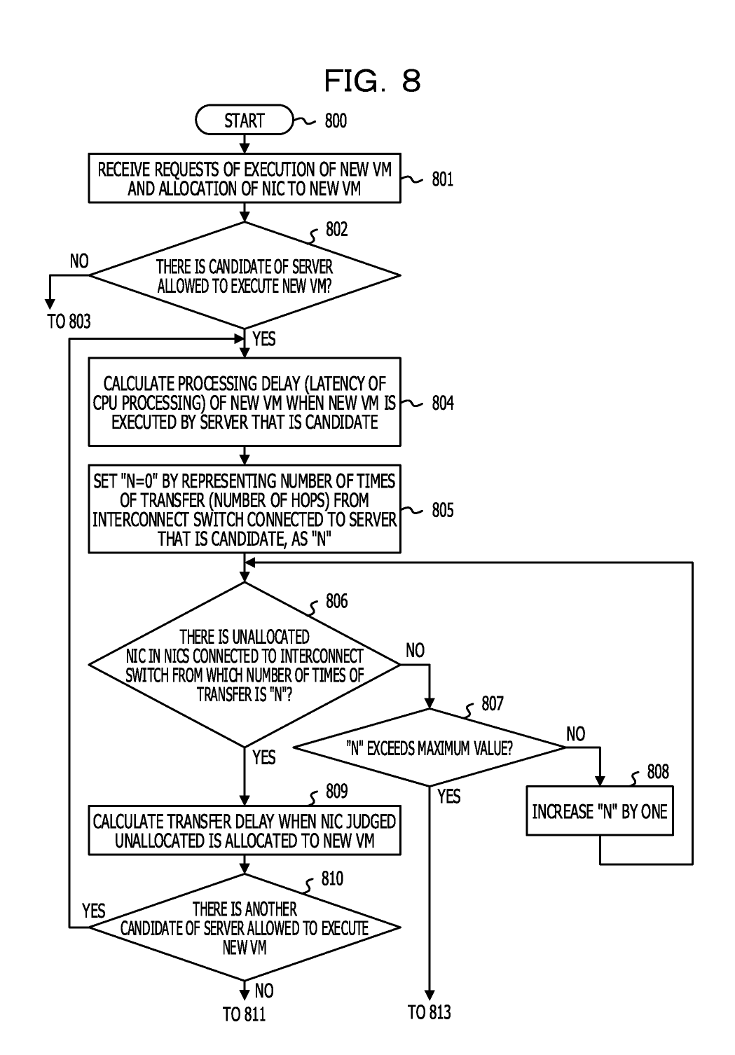

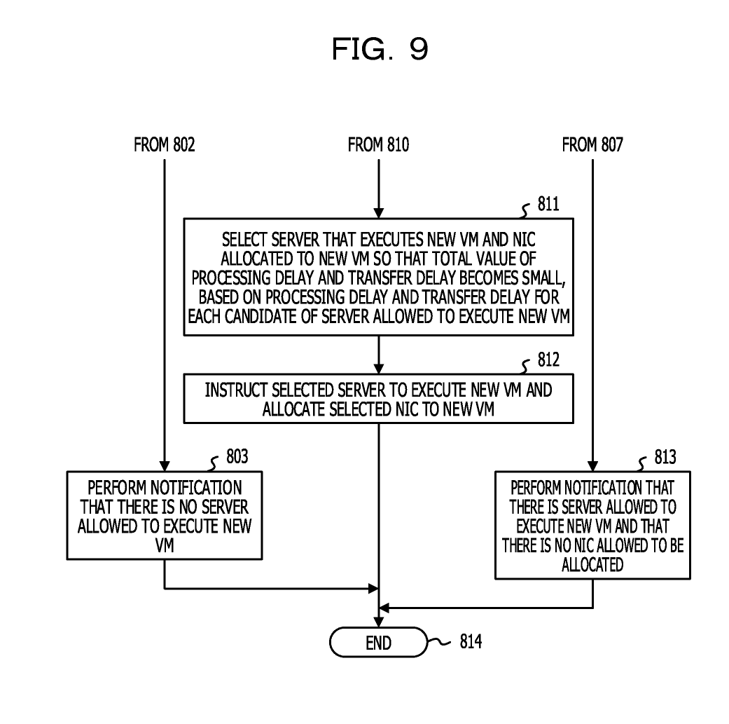

FIGS. 8 and 9 illustrate an example of the further processing that is executed by the management device according to the embodiment. The processing illustrated in FIGS. 8 and 9 is different from the pieces of processing illustrated in FIGS. 6 and 7, and in FIGS. 8 and 9, an example is illustrated in which when execution of a new VM and allocation of a NIC to the new VM are requested. In this case, both of processing delay of a server that executes the new VM and transfer delay when the NIC is allocated to the new VM are considered. In addition, by considering both of such processing delay and transfer delay, the server that executes the new VM and the NIC that is allocated to the new VM are selected. First, in an operation 800, the processing illustrated in FIG. 8 is started, and in an operation 801, requests of execution of the new VM and allocation of the NIC to the new VM are received from the management server 200. As illustrated in FIGS. 7 and 8, whether there are such requests may be monitored by the judgment unit 500.

In an operation 802, the judgment unit 500 judges whether there is a candidate of the server that is allowed to execute the new VM. When the judgment unit 500 judges that there is no candidate of the server, the flow proceeds to an operation 803, and when the judgment unit 500 judges that there is a candidate of the server, the flow proceeds to an operation 804.

In the operation 803, the notification unit 501 performs notification that there is no server that is allowed to execute the new VM. In the operation 802, the judgment unit 500 judges that there is no server that has enough hardware resources to allow the new VM to be executed, so that, in the operation 803, the notification unit 501 performs notification that there is no server that is allowed to execute the new VM on the basis of such a judgment result before the judgment unit 500 judges that whether there is an unallocated NIC. When the operation 803 is terminated, the flow proceeds to an operation 814.

When the judgment unit 500 judges that there is a candidate of the server in the operation 802, in the operation 804, the calculation unit 502 calculates processing delay of the new VM when the new VM is executed by the server that is the candidate. In the operation 804, for example, when the new VM is executed in addition to the VM that has been already executed in the server that is the candidate, latency of CPU processing such as context switch of the CPU is calculated.

In an operation 805, the setting unit 505 sets “N=0” by representing the number of times of transfer from the interconnect switch that is coupled to the server that executes the VM, as “N”. In the operation 805, the number of times (the number of hops) in which the packet that is transmitted from the VM is transferred between the interconnect switches is represented as “N”, and zero is set as an initial value of “N”. For example, the interconnect switch from which the number of times of transfer becomes zero corresponds to an interconnect switch that is coupled to the server that executes the VM, and the interconnect switch from which the number of times of transfer becomes one corresponds to an interconnect switch that is directly coupled to the interconnect switch that is coupled to the server that executes the VM. When zero is set to “N”, a NIC is searched for so that the number of times of transfer from the interconnect switch is reduced as least as possible, using the server that executes the VM as a reference.

In an operation 806, the judgment unit 500 judges whether there is an unallocated NIC in NICs that are coupled to the interconnect switch from which the number of times of transfer becomes “N”. As illustrated in FIG. 2, there is a case in which a NIC has been already allocated to one of the VMs, so that the judgment unit 500 judges whether there is an unallocated NIC in the NICs that are coupled to the transfer circuit from which the number of times of transfer becomes “N”, in the operation 806. When the judgment unit 500 judges that there is an unallocated NIC, the flow proceeds to an operation 809, and the judgment unit 500 judges that there is no unallocated NIC, the flow proceeds to an operation 807.

In the operation 807, the judgment unit 500 judges whether “N” exceeds the maximum value when it is judged that there is no unallocated NIC. When “N” exceeds the maximum value, for example, the number of times of transfer from the transfer circuit to which the server that executes the VM is coupled exceeds the maximum value depending on the number of interconnect switches and the connection configuration. The maximum value may set so as to be small as compared with the number of interconnect switches and the connection configuration.

When the judgment unit 500 judges that “N” does not exceed the maximum value, in an operation 808, the setting unit 505 perform setting so that “N” is increased by one. In addition, when the number of times of transfer is increased by increasing “N”, the flow proceeds to the operation 806 in order to judge whether there is an unallocated NIC. In addition, when the judgment unit 500 judges that “N” exceeds the maximum value, in an operation 813, the notification unit 501 performs notification that there is a server that is allowed to execute the new VM and that there is no NIC that is allowed to be allocated.

In the operation 809, the calculation unit 502 calculates transfer delay when the NIC that is judged unallocated is allocated to the new VM. In the operation 809, for example, the calculation unit 502 calculates a total value of processing delay that is caused by the processing in the transfer circuit and transfer delay between the transfer circuits when a packet is transferred from the server that executes the new VM to the NIC that is judged unallocated, as packet transfer delay on the basis of a simulation value of each delay for the size of the packet to be transferred.

In an operation 810, the judgment unit 500 judges whether there is a further candidate of the server that is allowed to execute the new VM. In a case in which the judgment unit 500 judges that there is a further candidate of the server, the flow proceeds to the operation 804 in order to calculate processing delay and transfer delay for the new VM when the server that is the further candidate executes the new VM. When the judgment unit 500 judges that there is no candidate any more, the flow proceeds to an operation 811.

In the operation 811, the selection unit 503 selects a server that executes the new VM and a NIC that is allocated to the new VM so that a total value of processing delay and transfer delay for each candidate of the server that is allowed to execute the new VM becomes small on the basis of the processing delay and the transfer delay.

For example, even in a case in which an unallocated NIC is searched for, and the VM is executed by a server that is coupled to an interconnect switch that is coupled to the NIC, when a plurality of VMs are executed by the server, processing performance of the newly executed VM is insufficient due to processing delay of context switch and the like, so that the processing performance of the plurality of VMs that have already been executed may be reduced undesirably. In addition, even in a case in which the server that has enough hardware resources is caused to execute the new VM, when the allocated NIC is a NIC that may not transmit the packet unless the packet passes through the interconnect switches of the multi-stages, a packet transfer takes a long time. Therefore, in the operation 811, on the basis of the calculation result that is obtained by the operations 804 and 809, total values of processing delay and transfer delay for the servers that are the candidates are compared with each other, and a server and a NIC for which such a total value becomes small are selected.

In an operation 812, the instruction unit 504 instructs the selected server to execute the new VM, and the allocation unit 506 allocates the selected NIC to the new VM. In the operation 812, the instruction unit 504 instructs the selected server 26 that is a VM manager to execute the new VM so that the total value of the processing delay and the transfer delay becomes small, and the allocation unit 506 allocates the selected NIC to the new VM.

In the operation 814, the processing illustrated in FIG. 8 is terminated. Similar to FIG. 7 and FIG. 8, the judgment unit 500 judges whether the processing is continued before the processing is terminated in the operation 814, and when the processing is continued, the flow may proceed to the operation 801.

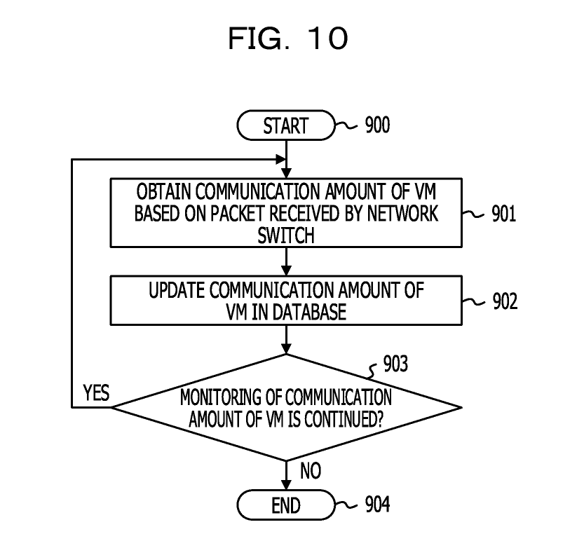

FIG. 10 illustrates an example of further processing that is executed by the management device according to the embodiment. In the processing illustrated in FIG. 10, when a VM is migrated or allocation of a NIC is changed as illustrated in FIG. 2, the reduction effect becomes small or the situation is worsened unless a communication amount of the VM is large to some extent. Therefore, the processing illustrated in FIGS. 11 and 12 is processing of monitoring such a communication amount of the VM in order to use a communication amount of the VM as a judgment condition. First, in an operation 900, the processing illustrated in FIG. 10 is started.

In an operation 901, the obtaining unit 507 obtains a communication amount of the VM on the basis of a packet that is received by the network switch. In the operation 901, the obtaining unit 507 obtains a communication amount of a VM that performs communication, on the basis of a destination MAC address that is included in the header portion of the packet that is received by the network switch 50 and a data amount of the packet.

In the operation 901, on the basis of a prediction amount that is described below, an average amount of the obtained communication amount and the prediction amount may be set as a communication amount of the VM. For example, an allocated band based on usage agreement that the client performs a service using the VMs, and the type of the application such as a large-scale data processing application type, a Web service type, and the other processing types of a mail, sensor information, and the like are recorded, and an amount of packets that are to be transferred until the VM ends, that is, a prediction amount of the communication amount may be estimated in accordance with the recorded information. In addition, in the interconnect switch, a prediction amount may be estimated using a communication amount in accordance with the port number of a port to which the packet that is transmitted from the VM is input.

In an operation 902, the update unit 508 updates the communication amount of the VM in a database on the basis of the obtained communication amount. In the operation 902, the update unit 508 updates the communication amount of the VM, which is obtained in the operation 901, for example, in the database that is achieved by the storage device 470 illustrated in FIG. 4.

In an operation 903, the judgment unit 500 judges whether monitoring of the communication amount of the VM is continued. When the judgment unit 500 judges that the processing is continued, the flow proceeds to the operation 901, and when the judgment unit 500 judges that the processing is not continued, the flow proceeds to an operation 904, so that the processing illustrated in FIG. 10 is terminated.

FIGS. 11 and 12 illustrate an example of further processing that is executed by the management device according to the embodiment. In the processing illustrated in FIGS. 11 and 12, the judgment unit 500 judges whether a transfer time of a packet is allowed to be reduced by performing migration of a VM or changing allocation of a NIC, for the VM to which the NIC has been already allocated and has executed communication, and when the transfer time of the packet is reduced, the migration of the VM or the change in allocation of the NIC is performed. First, in an operation 1000, the processing illustrated in FIGS. 11 and 12 is started. After the operation 1000, in an operation 1001, the setting unit 505 resets a counter that is associated with each of the VMs that are being executed.

In an operation 1002, the identification unit 509 identifies a VM that has a large communication amount on the basis of the database. In the operation 1002, as illustrated in FIG. 3, as communication has a large communication amount, a reduction effect of a packet transfer time when the migration of the VM or the change in allocation of the NIC is performed becomes large, so that the identification unit 509 identifies a VM that has a large communication amount.

In an operation 1003, the judgment unit 500 judges whether the NIC that is allocated to the identified VM is coupled to the server that executes the identified VM, or there is no unallocated NIC. When the NIC that is allocated to the identified VM is coupled to the server, the flow proceeds to the operation 1001, and when there is no unallocated NIC, the flow proceeds to an operation 1004.

In the operation 1004, the setting unit 505 increases a value of a counter that is associated with the identified VM, and in an operation 1005, the judgment unit 500 judges whether there is a counter the value of which exceeds a threshold value, out of the counters that are associated with the identified VM. When the judgment unit 500 judges that there is no counter the value of which exceeds the threshold value, the flow proceeds to the operation 1002. When the judgment unit 500 judges that there is a counter the value of which exceeds the threshold value, the flow proceeds to an operation 1006, and in the operation 1006, the management server 200 starts judgment of whether VM migration or change in allocation of the NIC is performed.

In an operation 1007, the judgment unit 500 judges whether there is a server that is a candidate of a migration destination. When the judgment unit 500 judges that there is no server that is the candidate, the flow proceeds to the operation 1002, and when the judgment unit 500 judges that there is a server that is the candidate, the flow proceeds to an operation 1008.

In the operation 1008, the calculation unit 502 calculates a first prediction time that includes a packet transfer time from the VM to the allocated NIC and a time that is taken to perform the VM migration when the VM is executed by the server that is the candidate.

First, in the operation 1008, the processing of calculating the packet transfer time from the VM to the allocated NIC is described. The number of VMs that are being executed in the server is represented as “VM number”, and processing delay per unit of time due to the context switch, which is increased each time a VM is increased in the server is represented as “Cd”. In addition, when the communication amount that is obtained in the operation 901 illustrated in FIG. 10 is divided, for example, by the most recent communication speed, “Time” that is a time that is taken until a VM that is a target terminates communication is calculated. In addition, “processing delay Dvm” by the context switch in the server is calculated by total of “VM number”, “Cd”, and “Time”.

Until the VM that is a target terminates the communication, “N” that is the number of times in which the VM that is a target accesses the interconnect switches becomes a value that is obtained by dividing the communication amount that is obtained in the operation 901 illustrated in FIG. 10, by the packet size. In addition, when delay per one time of transfer between the interconnect switches is represented as “Dhop” and the number of times of transfer is represented by “Nhop”, “Dbus” that is a delay time when access to the interconnect switch is performed one time becomes equal to the sum of “Dhop” and “Nhop”.

Therefore, “Dtarget” that is delay that occurs in the server that executes the VM that is a target until the VM that is a target terminates the communication (total of the delay in the interconnect switch and the delay of the processing in the server) is a value that is obtained by adding a product of “Dbus” and “N”, to “Dvm” (target).

In addition, “Dother” that is delay that occurs in a further server that does not execute the VM that is a target until the VM that is a target terminates the communication (total of delay of the processing in the server) is “ΣDvm” of a server other than the server that executes the VM (1 to n other than the target).

Therefore, “Dtotal” that is total of delay in the whole system, which occurs until the VM that is a target terminates the communication is a value that is obtained by adding a product of “Dbus” and “N”, to “ΣDvm” (1 to n).

Processing that is related to calculation of a time that is taken to perform the VM migration in the operation 1008 is described below. In the migration, information that indicates an execution state of the VM is transferred from a memory of a migration source server to a memory of a migration destination server. The VM is continued to be executed even during such transfer, so that the content of the memory may be updated during the transfer. Therefore, the updated portion is transmitted again as a difference. In addition, when an amount of the difference falls below a certain amount, execution of the VM by the migration source server is terminated, and the remaining portion of the difference is transferred to the migration destination server. After the transfer, the information that indicates the execution state of the VM is deleted from the migration source server, and the VM is executed by the migration destination server.

For example, when a large amount of data is processed by co-operation of a plurality of VMs, Oss, memory capacities, and various setting parameters in the plurality of VMs are set so as to be same level, so that VMs in which a time that is taken to perform the migration is substantially the same are estimated. Therefore, the time that is taken to perform the VM migration is obtained beforehand by simulation or the like, and the simulated time is stored in the memory 420 and may be used when a first prediction time is calculated by reading out such a time from the memory 420 as appropriate.

In accordance with the above-described pieces of processing, the first prediction time is calculated so as to include “Dtotal” and the time that is taken to perform the VM migration.

In an operation 1009, the judgment unit 500 judges whether there is a further candidate of a server that is a migration destination. In the operation 1009, the judgment unit 500 judges whether there is a candidate of the server that is the migration destination of the VM, in accordance with the usage status of the hardware resources of the servers 20 to 25 that are monitored by the server 26 that is the VM manager or the management server 200 and the power control status in the data center 100. When the judgment unit 500 judges that there is no candidate any more, the flow proceeds to an operation 1010. When the judgment unit 500 judges that there is a further candidate, the flow proceeds to the operation 1008.

In the operation 1010, the judgment unit 500 judges whether there is a candidate of the NIC that is allowed to be allocated to the VM. The management server 200 according to the embodiment allocates the NICs 30 to 41 to the VMs 1 to 5 and deallcoates the NICs 30 to 41 from the VMs 1 to 5. In addition, the management server 200 manages a correspondence relationship between the VM and the allocated NIC, and unallocated NICs, and stores such a correspondence relationship in the memory 420. In the operation 1010, the judgment unit 500 judges whether there is a candidate of the NIC that is allowed to be allocated to the VM, on the basis of such a correspondence relationship. When the judgment unit 500 judges that there is a candidate of the NIC, the flow proceeds to an operation 1012, and when the judgment unit 500 judges that there is no candidate of the NIC, the flow proceeds to an operation 1011.

In the operation 1011, the selection unit 503 selects whether the VM is migrated on the basis of the calculated first prediction time. The operation 1011 is an operation that is executed on the basis of a result when the judgment unit 500 judges that there is no NIC that is allowed to be allocated to the VM, in the operation 1010, so that whether the VM is migrated is selected in accordance with the first prediction time without consideration of change in allocation of the NIC.

For example, there is a case in which a time that is taken to perform the packet transmission is reduced as a result of the migration of the VM as compared in FIGS. 3B and 3D, but there is a case in which the time that is taken to perform the packet transmission is increased as illustrated in FIG. 3E. Therefore, in the operation 1011, a time in accordance with the calculated first prediction time and a time that is taken to perform the packet transmission when the VM is not migrated are compared with each other, and the selection unit 503 selects whether the VM is migrated.

In the operation 1012, the calculation unit 502 calculates a second prediction time that includes a packet transfer time from the VM to a NIC that is a candidate when the NIC is allocated to the VM, and a time that is taken to change allocation of the NIC.

The time that is taken to change allocation of the NIC in the operation 1012 may be calculated on the basis of the following time that is taken for setting. The following time that is taken for setting includes a time that is taken to execute processing of writing a MAC address after allocation change to a RAM that is included in a NIC that is used after allocation change, a time that is taken to execute processing of notifying the VM of identification information of the changed NIC and performing setting because communication between the interconnect switches 6 to 8 and the VMs is in accordance with identification information of the NIC, and a time that is taken to execute processing of reflecting a MAC address of the changed NIC to a correspondence relationship between a MAC address and a port included in the network switch 50, for the network switch 50 so that the packet is delivered to the changed NIC. These times may be individually calculated, and a time that is obtained by considering all of the times may be regarded as a substantially uniform time.

In an operation 1013, the judgment unit 500 judges whether there is a further candidate of the NIC that is allowed to be allocated to the VM. In the operation 1013, the judgment unit 500 judges whether there is a further candidate of the NIC in accordance with the above-described correspondence relationship that is stored in the memory 420. When the judgment unit 500 judges that there is a further candidate of the NIC, the flow proceeds to the operation 1012 in order to calculate a second prediction time that is related to the further candidate. In addition, when the judgment unit 500 judges that there is no candidate of the NIC any more, the flow proceeds to an operation 1014.

In the operation 1014, the selection unit 503 selects whether the VM is migrated, the NIC that is allocated to the VM is changed, or both of the VM migration and the change in allocation of the NIC are not performed on the basis of the calculated first prediction time and second prediction time.

As illustrated in FIG. 3, unless a time that is taken to perform the change in allocation of the NIC or the VM migration, processing delay in the server, transfer delay through the interconnect switches are considered comprehensively in order to reduce the packet transfer time, the whole communication time that is taken to perform the packet transmission is not reduced. Therefore, in the operation 1014, setting in which the communication time that is taken to perform the packet transmission is reduced is selected on the basis of the first prediction time and the second prediction time.

In an operation 1015, the judgment unit 500 judges whether the processing is continued. When the judgment unit 500 judges that the processing is continued, the flow proceeds to the operation 1002, and when the judgment unit 500 judges that the processing is not continued, the flow proceeds to an operation 1016, so that the processing illustrated in FIGS. 11 and 12 is terminated.

When a communication amount of the VM that is a target in the processing illustrated in FIG. 10 is large after the VM migration or the change in allocation of the NIC is performed, one of the VM migration or the change in allocation of the NIC that has not been executed is executed again in the processing illustrated in FIG. 10. For example, when allocation of a NIC that is coupled to an interconnect switch that is different from an interconnect switch that is coupled to the server that executes the VM is performed after the VM is migrated by being judged that the transfer time of the packet is reduced when the VM is migrated, the same VM that is judged again to have a large communication amount is regarded as a processing target, and change in allocation of the NIC may be performed. In addition, the VM migration may be performed after change in allocation of the NIC is performed.

In the above-described embodiments, in the communication system in which a packet that is delivered from the interconnect switch to which the server that executes the VM is coupled, to the NIC through a further interconnect switch, the judgment unit 500 judges whether the VM is executed by a further server that is coupled to the further interconnect switch.

In addition, in this case, a total value of a time that is taken to perform VM migration when the VM is executed by the further server and a time that is taken to deliver the packet that has been transmitted from the migrated VM, to the NIC that is coupled to the further interconnect switch, and a total value of a time that is taken to execute processing of changing the NIC that is allocated to the VM, to the NIC that is coupled to the interconnect switch to which the server that executes the VM is coupled and a time that is taken to deliver the packet from the VM to the newly allocated NIC after the NIC that is allocated to the VM is changed are compared with each other, and it is selected whether the VM is migrated or the allocation of the NIC is changed so that the transfer time of the packet from the VM to the NIC is further reduced.

Therefore, even when the plurality of interconnect switches that transfer the packet are coupled to each other, and the interconnect switch to which the server that executes the VM is coupled is different from the interconnect switch to which the NIC that is allocated to the VM is coupled, a time that is taken to deliver the packet that is transmitted from the VM that is being executed, to the NIC is allowed to be reduced depending on the usage status of the server.

All examples and conditional language recited herein are intended for pedagogical purposes to aid the reader in understanding the embodiments and the concepts contributed by the inventor to furthering the art, and are to be construed as being without limitation to such specifically recited examples and conditions, nor does the organization of such examples in the specification relate to a showing of the superiority and inferiority of the embodiments. Although the embodiments have been described in detail, it should be understood that the various changes, substitutions, and alterations could be made hereto without departing from the spirit and scope thereof.

What is claimed is:

1. An apparatus, comprising:
a memory; and
a processor coupled to the memory and configured to execute a process, the process comprising:
predicting a first time for transferring a packet as a predicted first time, where the predicting the first time is a prediction for transferring the packet from a second transfer circuit coupled to a second computer to a first communication circuit that transmits the packet to a network if a virtual machine is executed in the second computer, the virtual machine being executed in a first computer coupling to a first transfer circuit and generating the packet to be transmitted from a first transfer circuit to the first communication circuit through the second transfer circuit; and
determining whether the virtual machine is to be executed by the second computer based on the predicted first time.

2. The apparatus according to claim 1, wherein
the process includes:
predicting a second time as a predicted second time for transferring the packet from the first transfer circuit to a second communication circuit that transmits the packet to the network if the second communication circuit is allocated to the virtual machine; and
determining whether the virtual machine is to be executed by the second computer or a second communication circuit is allocated to the virtual machine, based on the predicted first time and the predicted second time.

3. The apparatus according to claim 1, wherein
the predicted first time includes a migration time for migrating the virtual machine from the first computer to the second computer.

4. The apparatus according to claim 1, wherein
the predicted first time includes a wait time when the virtual machine executed by the second computer waits processing by another virtual machine that has been already executed by the second computer.

5. The apparatus according to claim 1, wherein
the process includes:
causing the second computer to execute the virtual machine when the predicted first time is equal to or less than a transfer time for transferring the packet from the first transfer circuit to the first communication circuit.

6. The apparatus according to claim 1, wherein
the process includes:
causing the second computer to execute the virtual machine based on the predicted first time, so that a number of transfer circuits through which the packet is transferred is reduced.

7. The apparatus according to claim 1, wherein
the process includes:
causing the second computer to execute the virtual machine based on the predicted first time so that the packet is transferred to the first communication circuit without passing through the first transfer circuit.

8. The apparatus according to claim 1, wherein
the process includes:
determining whether the virtual machine is to be executed by the second computer when a communication amount of the virtual machine exceeds a specific amount.

9. The apparatus according to claim 2, wherein
the predicted second time includes a changing time for changing a communication circuit that is allocated to the virtual machine, from the first communication circuit to the second communication circuit.

10. A system, comprising:
a first computer configured to execute a virtual machine generating a packet;
a first transfer circuit coupled to the first computer and configured to transfer the packet;
a first communication circuit configured to transmit the packet to a network;
a second transfer circuit configured to transfer the packet from the first transfer circuit to the first communication circuit; and
an apparatus configured to:
predict a first time for transferring a packet as a predicted first time, where to predict the first time is a prediction for transferring the packet from a second transfer circuit coupled to a second computer to a first communication circuit that transmits the packet to a network if a virtual machine is executed in the second computer, the virtual machine being executed in a first computer coupling to a first transfer circuit and generating the packet to be transmitted from a first transfer circuit to the first communication circuit through the second transfer circuit, and
determine whether the virtual machine is executed by the second computer based on the predicted first time.

11. A method, comprising:
predicting a first time for transferring a packet as a predicted first time, where the predicting the first time is a prediction for transferring the packet from a second transfer circuit coupled to a second computer to a first communication circuit that transmits the packet to a network if a virtual machine is executed in the second computer, the virtual machine being executed in a first computer coupling to a first transfer circuit and generating the packet to be transmitted from a first transfer circuit to the first communication circuit through the second transfer circuit; and
determining whether the virtual machine is to be executed by the second computer based on the predicted first time.

12. A non-transitory computer-readable recording medium having stored therein a program for causing a system to execute a process, the process comprising:
predicting a first time for transferring a packet as a predicted first time, where the predicting the first time is a prediction for transferring the packet from a second transfer circuit coupled to a second computer to a first communication circuit that transmits the packet to a network if a virtual machine is executed in the second computer, the virtual machine being executed in a first computer coupling to a first transfer circuit and generating the packet to be transmitted from a first transfer circuit to the first communication circuit through the second transfer circuit; and
determining whether the virtual machine is to be executed by the second computer based on the predicted first time.

13. A method, comprising:
determining whether a virtual machine to generate a packet is to be executed by a first computer or a second computer, comprising:
determining a first processing time of processing the packet for a network by the first computer with a transfer through interconnect switches connected to the first and second computers and through a network interface card connected between the interconnect switches and a network switch;
determining a second processing time of a transfer between the second computer and the network switch through the interconnect switches and the network interface card; and
selecting the one of the first and second computers having the lowest processing time based on the first processing time and the second processing time.

14. A method according to claim 13, wherein
the first processing time comprises a network interface card transfer time to allocate another network interface card to the first computer, and the second processing time comprises a virtual machine transfer time associated with transferring the virtual machine generating the packet from the first computer to the second computer.
